(19) United States
(12) Patent Application Publication
(10) Pub. No.: US 2006/0201060 A1
(43) Pub. Date: Sep. 14, 2006

(54) System for attaching objects to vertically elongated structures

(76) Inventors: Jerry Warman, Borden, IN (US); Barbara Warman, Borden, IN (US)

Correspondence Address: JAMES RAY & ASSOCIATES, 2640 PITCAIRN ROAD, MONROEVILLE, PA, 15146, US

(21) Appl. No.: 11/367,980

(22) Filed: Mar. 3, 2006

Related U.S. Application Data
(60) Provisional application No. 60/660,057, filed on Mar. 9, 2005.

(51) Int. Cl. A01G 9/02; A47G 7/02

(52) U.S. Cl. 47/65.5; 47/67

(57) ABSTRACT

A system for attaching at least one preselected object to a vertically disposed elongated structure includes a strap, a fastening member for securing and releasing connecting opposed ends of the strap. A tensioning device engageable with at least one of the fastening member and the strap for forming a predetermined tension within the strap fastened to such structure with the fastening member, wherein the predetermined tension enables the strap to be securely wrapped around a peripheral surface portion of such structure. Various members are engageable with the strap for removably receiving such at least one preselected object and for enabling attachment of such at least one preselected object to such structure.

### CROSS-REFERENCE TO RELATED APPLICATIONS

This application is related to and claims priory from Provisional Patent Application Ser. No. 60/660,057 filed Mar. 09, 2005.

### FIELD OF THE INVENTION

The present invention relates, in general, to a system for attaching preselected objects to vertically disposed elongated structures and, more particularly, this invention relates to a system for attaching living plants and decorative ornaments to trees, columns; posts and the like.

### BACKGROUND OF THE INVENTION

As is generally well known, those who desire to attach living plants and decorative objects to vertically disposed elongated structures such as trees, columns, posts and the like must use fasteners, such as nails and screws, which typically cause irreparable damage and harm to such structures and therefore are undesirable for use due to such damage. Furthermore, attachment of such preselected objects using fasteners is often performed on a permanent or semi-permanent fashion in order to avoid further damage caused by relocation of such preselected objects.

Therefore, there is a need for an improved system for attaching preselected objects to vertically disposed elongated structures which provides a user flexibility to easily relocate or replace such preselected objects without damage to the vertically disposed elongated structures.

### SUMMARY OF THE INVENTION

The invention provides a system for attaching at least one preselected object to a vertically disposed elongated structure. Such system includes a strap having a predetermined size. A fastening member to securely and releasably connect opposed ends of the strap. Provision is provided for forming a predetermined tension within the strap fastened to such structure with the fastening member. Such predetermined tension enables the strap to be securely wrapped around a peripheral surface portion of such structure. Various members engageable with the strap are provided for removably receiving such at least one preselected object and for enabling attachment of such at least one preselected object to such structure.

### OBJECTS OF THE INVENTION

It is, therefore, one of the primary objects of the present invention to provide a system for attaching preselected objects to vertically disposed elongated structures.

Another object of the present invention is to provide a system for attaching preselected objects to vertically disposed elongated structures, which eliminates damage to such structures during attachment and use of such preselected objects.

Yet another object of the present invention is to provide a system for attaching preselected objects to vertically disposed elongated structures which enables attachment of a wide variety of objects.

A further object of the present invention is to provide a system for attaching preselected objects to vertically disposed elongated structures which is simple to use.

Yet a further object of the present invention is to provide a system for attaching preselected objects to a wide variety of vertically disposed elongated structures.

An additional object of the present invention is to provide a system for attaching preselected objects to vertically disposed elongated structures which employs a strap securely wrapped around such structure.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view of a system for attaching preselected objects to a vertically disposed elongated structure;

FIG. 2 is a partial perspective view of the system of FIG. 1, particularly showing a fastening member of the presently preferred embodiment of the invention;

FIG. 3 is a partial perspective view of the system of FIG. 1, particularly showing an object holder of one embodiment of the invention;

FIG. 4 is a partial perspective view of the system of FIG. 1, particularly showing an object holder of another embodiment of the invention; and

FIG. 5 is a plan view of the system of FIG. 1, particularly illustrating a strap member of an alternative embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

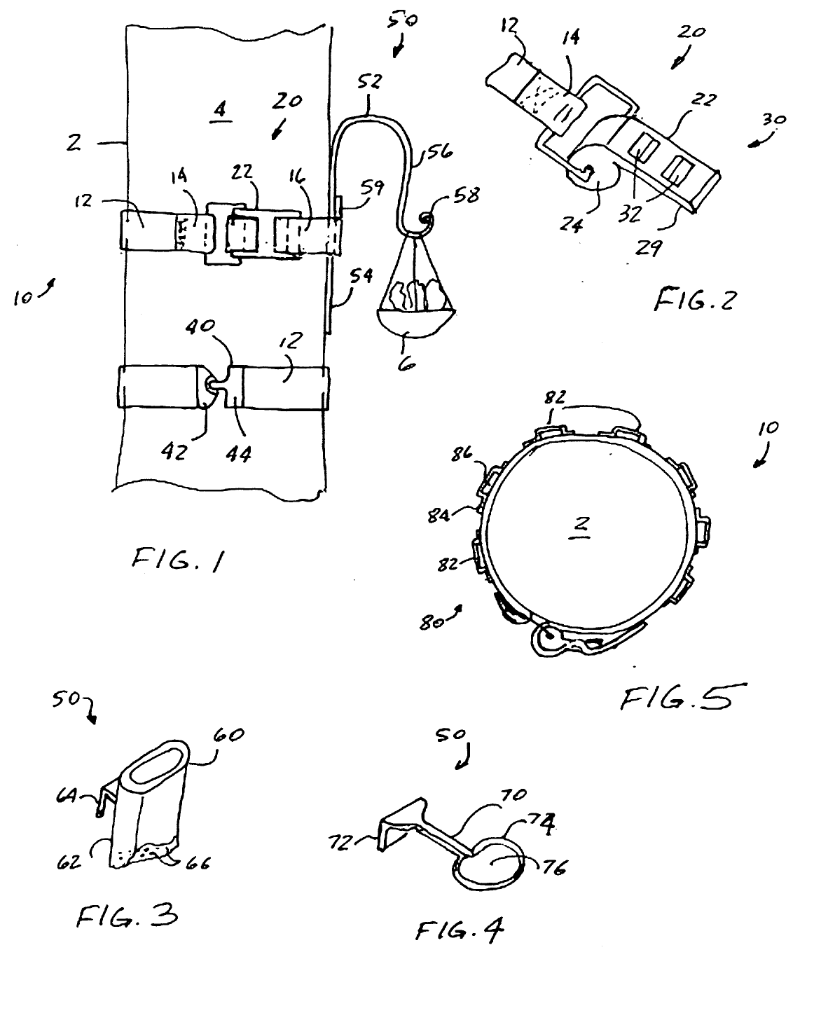

Reference is now made, to FIGS. 1-5, wherein there is shown a system, generally designated 10, for attaching at least one preselected object 6 to a vertically disposed elongated structure 2. In particular reference to FIG. 1, such system 10 includes a strap 12 of a predetermined size which is wrapped around the peripheral surface portion 4 of the structure 2. Another essential element of the present invention is a fastening means, generally designated 20, provided for securely and releasably connecting opposed ends of the strap 12.

A further essential element of the present invention is a means, generally designated 30, engageable with at least one of the fastening means 20 and the strap 12 for forming a predetermined tension within the strap 12 being fastened with the fastening means 20. Such predetermined tension enables the strap 12 to be securely wrapped around a peripheral surface portion 4 of such structure 2.

Now in particular reference to FIG. 2, fastening means 20 of a presently preferred embodiment of the invention includes a lever 22 having a first generally cylindrical portion 24 pivotally attached to a first end 14 of the strap 12 and forming a gap 28 between such first end 14 of strap 12 and a surface 26 of the first generally cylindrical portion 24. The lever 22 further has a second portion 29 extending outwardly from the first generally cylindrical portion 24.

The tension forming means 30 includes a pair of spaced apertures 32 disposed within the second portion 29 of lever 22. In such embodiment, the predetermined tension is formed by first inserting the second end 16 of the strap 12 into the gap 28, wrapping the second end 16 around the surface 26 of the first generally cylindrical portion 24, then inserting the second end 16 into a first aperture 32, extracting the second end 16 through a second aperture 32 and then pulling onto the second end 16 to feed a remaining length of the strap 12 through the pair of apertures 32 and rotating the second portion 29 of the lever 22 in a direction away from the first end 14 of the strap 12, wherein such lever 22, behaving in a cam-like fashion during rotation, aids in forming the predetermined tension within the strap 12.

In further reference to FIG. 1, such fastening means 20 of an alternative embodiment may be a clasp 40 having a first portion 42 attached to one end of the strap 12 and a second portion 44 attached to another end of the strap 12 and the tension forming means 30 is a material having a predetermined elasticity being used as the strap 12, whereby the strap 12 is first stretched, enabled by such predetermined elasticity, to connect the first portion 42 to the second portion 44.

Alternatively, such fastening means 50 may be a well known loop and hook type fastener (not shown).

Yet another essential element of the present invention is a means, generally designated 50, which is engageable with at least the strap 12 for removably receiving and holding such at least one preselected object 6 and for enabling attachment of such at least one preselected object 6 to such structure 2.

According to one embodiment of the invention, such object receiving means 50 is an elongated member 52 formed into a predetermined shape characterized by a first portion 54 disposed in a generally vertical direction when such at least one preselected object 6 is attached to such structure 2 and a second portion 56 extending outwardly from the first portion 54 and terminating with a hook 58 for suspending such at least one object 6.

The first portion 54 may be inserted intermediate such structure 2 and the strap 12 and may be provided with a stop member 59 rigidly attached to the first portion 54 of the elongated member 52 for disposing the hook 58 of the second portion 56 at a predetermined vertical distance from an edge of the strap 12. When the preselected object 6 is attached to the hook 58, the free end of the first portion 54 will move in a direction towards the structure 2 thus providing a support for the elongated member 52 having such at least one preselected object 6 being attached thereto. Such elongated member 52 is advantageous in attaching a preselected object 6 such as a flower basket or a lantern.

According to another embodiment of the invention, best shown in FIG. 3, such object receiving means 50 is a pocket 60, which may have a surface 62 rigidly attached to the strap 12 or may be provided with a hook member 64 engageable with a predetermined portion of the pocket 60, generally the surface 62 thereof, for removable attachment of such pocket 60 to the strap 12, wherein a portion of the hook member 64 is disposed intermediate such structure 2 and the strap 12. Such pocket 60 may be advantageous in growing living plants without the use of conventional plant containers, wherein the pocket 60 is further provided with drainage apertures 66 or for holding tools during a construction project.

According to yet another embodiment of the invention, best shown in FIG. 4, such object receiving means 50 includes a hanger 70 having a first portion 72 insertable intermediate such structure 2 and the strap 12 and a second portion 74 extending outwardly and generally horizontally from the first portion 72 and such structure 2 and having an aperture 76 formed therein for removably receiving such at least one preselected object 6.

Preferably, such hanger 70 is formed from a rod like elongated material. Alternatively, the hanger 70 may be molded from a thermoplastic material. It will be apparent to those skilled in the art that the hanger 70 is advantageous for attaching a well known flower pot to such structure 2.

In applications, wherein such vertically elongated structure 2 is a tree and it is desirable to protect the surface thereof from damage potentially caused by contact with a portion of the object receiving means 50, the system 10 may be provided with a means, generally designated 80, and best shown in FIG. 5, which is engageable with an exterior surface of the strap 12 wrapped around such structure 2 for caging at least one of a predetermined portion of the object receiving means 50 and predetermined portion of such at least one preselected object 6 and for enabling the attachment of such at least one preselected object 6 to such structure 2.

Such caging means 80 is, preferably, a predetermined plurality of flanged U-shaped members 82 securely attached to the strap 12 with a fastening means 84 being one of adhesive, stitching and various combinations thereof. Alternatively, the caging means 80 may be formed integral to the strap 12 during manufacturing process.

The aperture 86 formed intermediate the flanged U-shape member 82 and the strap 12 is sized to securely receive stop member 59 rigidly attached to the first portion 54 of the elongated member 52, the hook member 62 of the pocket 60, or the first portion 72 of the hanger 70 thus enabling attachment of the object receiving means 50 according to various embodiments of the invention.

A material of the strap 12 may be any well known material, for example nylon, capable of withstanding adverse weather conditions during use of the system 10. Additionally a layer of an elastomeric material may be applied to at least a portion of the surface of such strap 12 oriented towards the structure 2 for cushioning engagement of the strap 12 therewith or for preventing slippage of the strap 12 during use. It will be appreciated that the strap 12 manufactured from an elastomeric material will be advantageous in applications requiring such strap 12 to be stretched prior to fastening opposed ends thereof in order to form such predetermined tension.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A system for attaching at least one preselected object to a vertically disposed elongated structure, said system comprising:
(a) a strap having a predetermined size;
(b) a fastening means for securely and releasably connecting opposed ends of said strap;
(c) means engageable with at least one of said fastening means and said strap for forming a predetermined tension within said strap fastened to such structure with said fastening means, said predetermined tension enabling said strap to be securely wrapped around a peripheral surface portion of such structure; and
(d) means at least engageable with said strap for removably receiving such at least one preselected object and for enabling attachment of such at least one preselected object to such structure.

2. The system, according to claim 1, wherein said fastening means is a lever including a first generally cylindrical portion pivotally attached to a first end of said strap and forming a gap between said first end of said strap and a surface of said first generally cylindrical portion, said lever further including a second portion extending outwardly from said first generally cylindrical portion and said tension forming means is a pair of spaced apertures disposed within said second portion of said lever, whereby said predetermined tension is formed by first inserting said second end of said strap into said gap, wrapping said second end around said surface of said first generally cylindrical portion, then inserting said second end into a first aperture, extracting said second end through a second aperture and then pulling onto said second end to feed a remaining length of said strap through said pair of apertures, whereby said second portion of said lever is disposed in a direction away from said first end of said strap when said predetermined portion is formed therein.

3. The system, according to claim 1, wherein said fastening means is a clasp having a first portion attached to one end of said strap and a second portion attached to another end of said strap and said tension forming means is a predetermined elasticity of said strap, whereby said strap is first stretched to connect said first portion to said second portion.

4. The system, according to claim 1, wherein said object receiving means is an elongated member formed into a predetermined shape characterized by a first portion disposed in a generally vertical direction when such at least one preselected object is attached to such structure and a second portion extending outwardly from said first portion and terminating with a hook for suspendably receiving such at least one preselected object.

5. The system, according to claim 4, wherein said first portion is inserted intermediate such structure and said strap.

6. The system, according to claim 4, wherein said system includes a stop member rigidly attached to said first portion of said elongated member for disposing said hook of said second portion at a predetermined vertical distance from an edge of said strap.

7. The system, according to claim 4, wherein said system includes at least one U-shaped member engageable with an exterior surface of said strap wrapped around such structure, said U-shaped member caging a stop member rigidly attached to said first portion of said elongated member for disposing said hook of said second portion at a predetermined vertical distance from an edge of said strap and said first portion is inserted through said at least one U-shaped member for attaching such at least one preselected object to such structure.

8. The system, according to claim 1, wherein said object receiving means is a pocket.

9. The system, according to claim 8, wherein said pocket is rigidly attached to said strap.

10. The system, according to claim 8, wherein said pocket includes a hook member engageable with a predetermined portion of said pocket for removable attachment of said pocket to said strap, wherein a portion of said hook member is disposed intermediate such structure and said strap.

11. The system, according to claim 1, wherein said object receiving means includes a first portion insertable intermediate such structure and said strap and a second portion extending outwardly and generally horizontally from said first portion and such structure and having an aperture formed therein for removably receiving such at least one preselected object.

12. The system, according to claim 11, wherein said object receiving means is formed from a rod like elongated member.

13. The system, according to claim 1, wherein said system further includes an anti-slip means engageable with at least a portion of said strap.

14. The system, according to claim 1, wherein said system further includes means engageable with said strap for cushioning engagement of said strap with such structure.

15. The system, according to claim 1, wherein said strap includes means engageable with an exterior surface of said strap wrapped around such structure for caging at least one of a predetermined portion of said object receiving means and a predetermined portion of such at least one preselected object and for enabling said attachment of such at least one preselected object to such structure.

16. The system, according to claim 15, wherein said caging means is a predetermined plurality of U-shaped members.

17. The system, according to claim 16, wherein said U-shaped member is securely attached to said strap by one of fasteners, adhesive, stitching and various combinations thereof.

18. The system, according to claim 16, wherein said U-shaped member is integrally formed within said strap during manufacturing thereof.

19. A method for attaching at least one preselected object to a vertically disposed elongated structure, said method comprising the steps of:
(a) wrapping a strap around a peripheral surface portion of such structure, said strap having a predetermined size;
(b) forming a predetermined tension within said strap wrapped around such structure in step (a);
(c) securing opposed ends of said strap; and providing means engageable with said strap for receiving such at least one preselected object and for enabling attachment of such at least one preselected object to such structure.
